(19) United States
(12) Patent Application Publication
(10) Pub. No.: US 2007/0095304 A1
(43) Pub. Date: May 3, 2007

(54) System for Monitoring the Environment of an Animal

(76) Inventors: Maury Rosenberg, Old Greenwich, CT (US); John A. Credaroli JR., Cos Cob, CT (US); Martin Rogers, Yorktown Heights, NY (US)

Correspondence Address: ST. ONGE STEWARD JOHNSTON & REENS, LLC, 986 BEDFORD STREET, STAMFORD, CT, 06905-5619, US

(21) Appl. No.: 11/554,325

(22) Filed: Oct. 30, 2006

Related U.S. Application Data
(60) Provisional application No. 60/731,357, filed on Oct. 28, 2005.

(51) Int. Cl. A01K 15/02

(52) U.S. Cl. 119/720

(57) ABSTRACT

A system for monitoring the environment of an animal is disclosed generally comprising a video acquisition device worn by the animal and a monitoring device with which a remotely located user can monitor the animal's environment. The video acquisition device includes a camera for acquiring video, a transmitter for wirelessly transmitting the video to the monitoring device, and a rotation device for stabilizing the viewpoint of the camera regardless of the position of the animal. In certain embodiments, the camera is connected to an animal collar via a mount that has a rotating portion such that the camera rotates. In some embodiments, the rotating portion has a counterweight affixed thereto such that the camera rotates when the angle of inclination of the camera changes.

### CROSS-REFERENCE TO RELATED APPLICATIONS

This patent application claims the benefit of, under Title 35, United States Code, Section 119(e), U.S. Provisional Patent Application No. 60/731,357, filed Oct. 28, 2005.

### FIELD OF THE INVENTION

The present invention relates to a system for monitoring the environment of an animal. More specifically, the invention relates to a camera worn by the animal that acquires, orients, and wirelessly transmits video to a remote location.

### BACKGROUND OF THE INVENTION

Systems for tracking and/or monitoring the location and surroundings of an animal are generally well known in the art. Such systems are desirable for a number of reasons, including locating, training, and studying the animals themselves, as well as applications that use animals for viewing the environments in which the animals are located.

For example, one common application of such animal monitoring systems are those employed by pet owners to keep track of roaming pets or to locate a lost animal. Pets can move in unknown directions over a large area and, as a result, often wander far from their homes and become lost. A number of mechanisms have been created to locate these lost pets. For instance, pet collars have been developed to help notify bystanders that the pet is lost, including collars that allow the pet owner to remotely activate a visual display located on the collar, such as an inflatable balloon inscribed with a message, flashing lights, or an electronic display. Although these systems may alert bystanders in the immediate vicinity that the pet is lost, they do not help the owner determine the pet's location, and thus, such devices depend solely on a bystander contacting the pet owner.

A number of systems have also been proposed that employ wireless communication capabilities, such as those employing global positioning satellite services. However, in addition to being expensive, these devices only generate data for calculating the pet's specific location, conveying little information about the pet's immediate environment. However, it is often helpful for the pet owner to observe the pet's surroundings and conditions, not just the representation of the pet's location on a map, particularly for those pet owners who are trying to locate the animals in small but confusing territory, such as wooded areas.

Other applications where information about an animal's immediate surroundings is important are those where it is desired to study the behavior of animals, such as the periodic monitoring of a particular, individual animal during training, or for general research regarding the behaviors of certain types of animals. Behavioral studies in the wild are often difficult and complicated, as the subject animals are moving targets, hide in forests or underbrush, and, in many cases, are active only at night. The challenges of studying these free-ranging animals are further complicated by environmental impediments, such as extreme temperatures, high humidity, low visibility, and other factors related to climate and geography that are often encountered by the researcher. Additionally, many animals have evolved extraordinary sensory capabilities that keep them keenly attuned to the slightest disturbance to their natural habitat, yet, in order to observe and understand animals in their natural state, the researcher needs to get close to them. The closer the researcher gets, the more he/she is likely to influence and affect the behavior under study.

In order to eliminate the effect of a human presence, small radio and satellite transmission systems have been used to help keep researchers connected to their subjects from a distance and study their movement patterns, free of human influence. While such devices relay information on location and movement patterns in the wild and have yielded valuable data on home ranges, migratory routes, and temporal activity patterns, they cannot tell scientists what an animal is actually doing at a given location and time. While current collar-tags provide invaluable information on animal location and range, many of the details of animal behavior must still be inferred, as such systems do not provide a comprehensive view of an animal's perspective that would provide detailed data on habitat use, foraging strategies, social interactions, etc.

Yet other applications for such monitoring systems are those in which it is desired to use the animal as a remote viewing or early warning tool, such as in the case of security systems. Often, it is desirable to use animals, such as guard dogs, to ensure that a particular location remains secure, such as a dwelling that the homeowner wishes to protect again burglars, or an installation that may come under attack, such as a terrorist target or military base.

The use of animals to perform this function can serve a variety of purposes. First, it allows the humans who are monitoring the security level of the property to do so from the safety of a remote location, minimizing the dangers presented by potential intruders as well as the discomfort of being exposed to the elements. Moreover, for large areas, the use of guard dogs to patrol the property minimizes the number of humans required to effectively monitor the area, as a single individual can simultaneously monitor multiple remote locations using multiple dogs.

For these reasons, safety, convenience, and expense can all be significantly improved by employing a system that permits a user to remotely view the environments of animals. While a number of devices have been proposed that monitor the physical condition of the animal or allow the user to hear and/or analyze the bark of a dog, these systems still require a degree of interpretation to decipher precisely what is happening at the dog's location.

As a result of the needs of these various applications, a number of systems have been developed that allow a user to actually view the environment in which the animal is located. These devices typically include a video camera that is mounted to the animal. In order to maximize stability and viewing ability, it has been suggested to use a camera mounted to an animal's collar, such as in the systems disclosed in U.S. Pat. No. 6,782,847 to Shemesh et al., U.S. Pat. No. 6,720,879 to Edwards, U.S. Patent Application No. 2006/0011146 by Kates, and U.S. Patent Application No. 2005/0162279 by Marshall et al. By using such devices, a person is able to view the environment in which the animal is moving from a location remote from the animal.

However, one problem with these devices is that, though various locations on the neck of the animal have been tested in order to find the most ideal positioning of the camera, no location is truly satisfactory, as the anatomy of animals such as dogs renders the perspective of the video camera very irregular when the dog alters its position. Specifically, it has been discovered that the position of a dog's neck does not maintain a fixed relationship relative to the dog's viewing direction, but rather, changes significantly depending upon whether the dog is sitting, standing, laying down, running, or jumping. As a result, the camera can often provide video that is useless and does not really reflect what the dog is seeing.

What is desired, therefore, is a system that allows a user located remotely from an animal to monitor the environment of that animal. What is further desired is such a system for monitoring the environment of an animal that provides the user with a real-time view of the animal's location. What is also desired is such a monitoring system that provides a view of the animal's location that continually reflects what the animal is seeing, regardless of its position.

### SUMMARY OF THE INVENTION

Accordingly, it is an object of the present invention to provide a system for monitoring the environment of an animal that allows a user to monitor the animal from a remote location.

It is a further object of the present invention to provide a system for monitoring the environment of an animal that allows a user to view the environment in which the animal is located.

It is yet another object of the present invention to provide a system for monitoring the environment of an animal that allows the user to view the environment in real-time.

It is still another object of the present invention to provide a system for monitoring the environment of an animal that accounts for the various changes in the relationship between the animal's position and viewing direction.

In order to overcome the deficiencies of the prior art and to achieve at least some of the objects and advantages listed, the invention comprises a system for monitoring the environment of an animal, including a video acquisition device worn by an animal moving in an environment, and a monitoring device with which a user remotely monitors the environment in which the animal moves, wherein the video acquisition device comprises a camera with a view vector that acquires video data, a transmitter that wirelessly transmits the video data to the monitoring device, and a rotation device that substantially maintains a vertical angle of the view vector as the animal moves, and wherein the monitoring device comprises a receiver that receives the wirelessly transmitted video data from the video acquisition device, and a display that displays the video data as live video to the user.

In another embodiment, the invention comprises a device for monitoring the environment of an animal, including a device for monitoring the environment of an animal, including a collar that is worn by the animal, a camera mounted to the collar, and a mount by which the camera is mounted to the collar, wherein the mount comprises a rotation device for rotating the camera.

In yet another embodiment, the invention comprises a system for monitoring the environment of an animal from a different location, including a collar that is worn by the animal moving in an environment, and a camera mounted to the collar that acquires video of the environment, wherein the camera wirelessly transmits the video to the different location, and wherein the camera is mounted to the collar such that the camera rotates when the angle of inclination of the camera changes.

In certain embodiments, the rotation is produced by a rotating mount portion coupled to a non-rotating mount portion by a bearing. In some of these embodiments, the bearing comprises a rotation retarding bearing that retards the speed of the rotating portion, which in some cases, comprises a friction bearing.

In some embodiments, a counterweight is affixed to the rotation portion such that, when the angle of inclination of the camera changes, the camera rotates.

In certain embodiments, the invention further includes at least one battery electrically connected to the camera, wherein the battery is mounted to the collar. In some of these embodiments, a container is mounted to the collar with a surface that abuts the collar, the battery is disposed therein, and the surface has an opening for accessing the battery. In other embodiments, the collar includes a plurality of segments, and the invention further includes a plurality of cell batteries disposed in the plurality of segments and connected in series.

In certain embodiments, the monitoring device includes a converter that converts the wireless transmission to USB.

### BRIEF DESCRIPTION OF THE DRAWINGS

FIG. 1 is a perspective view of a video acquisition device and monitoring station representing a system for monitoring the environment of an animal in accordance with the invention.

FIG. 2A is an isometric view of a video acquisition device employed in the system of FIG. 1 in an assembled state.

FIG. 2B is an isometric, exploded view of the video acquisition device of FIG. 2A.

FIG. 3 is a perspective view of a video acquisition device employed in the system of FIG. 1.

FIG. 4 is a perspective view of part of a video acquisition device employed in the system of FIG. 1.

FIG. 5 is a schematic view of a network of devices employing the video acquisition device of FIG. 1.

FIG. 6 is a schematic view of a network of devices employing the video acquisition device of FIG. 1.

### DETAILED DESCRIPTION OF THE INVENTION

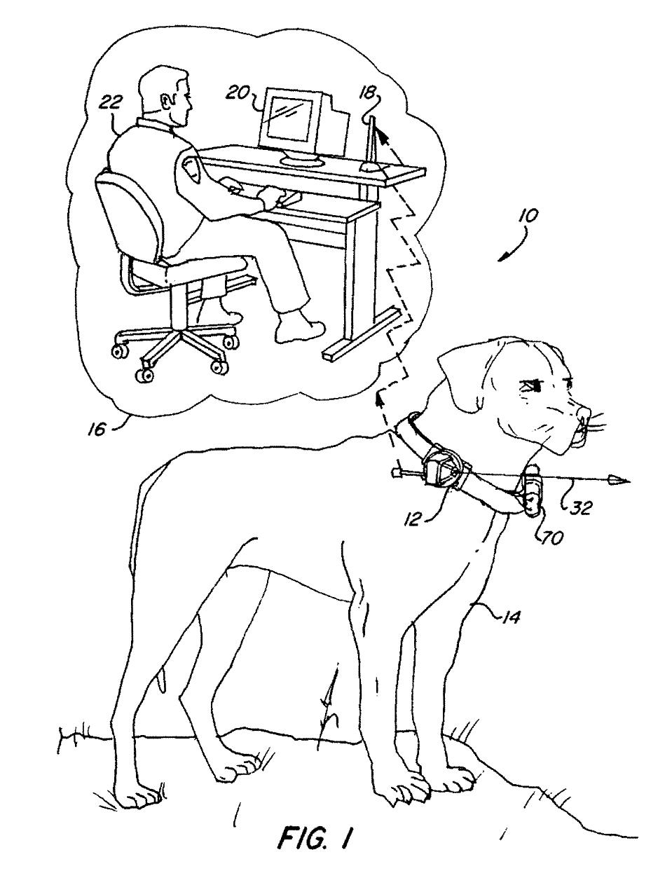

The basic components of one embodiment of a system for monitoring the environment of an animal in accordance with the invention are illustrated in FIG. 1. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The system 10 includes a video acquisition device 12, which is worn by an animal 14, such as a guard dog. In the embodiment illustrated, the video acquisition device 12, further described below, acquires video data, which it then transmits to a monitoring station 16. The monitoring station 16 includes a monitoring device for viewing the video data, including, for example, a receiver 18 for receiving the video data and a display 20 for rendering the data as live video to a user 22.

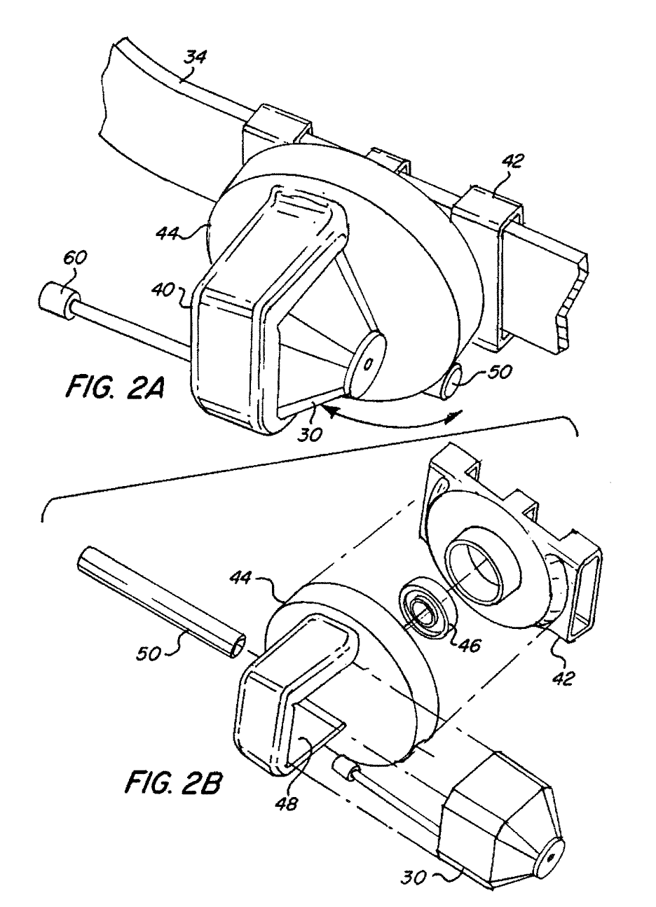

As shown more clearly in FIGS. 2A-B, the video acquisition device 12 includes a video camera 30, which may for example, comprise a CCTV camera. In certain advantageous embodiments, the camera 30 is a mini digital camera, with a transmission frequency of approximately 2.4 GHz, such as, for example, the MicroCam 4 manufactured by Swann Communications. Such cameras are small and light with minimal electronic components, such that they are not burdensome for the animal, yet they can transmit video to a monitoring station up to approximately 100 meters from the location of the animal 14. It should be noted, however, that any type of camera for capturing video may be employed, including an analog video camera used in conjunction with an A/D converter. The camera also includes a transmitter antenna 60 for wirelessly transmitting the video signal containing the data obtained by the camera 30, as is further described below.

The camera 30 is mounted to a collar 34, which is worn by the animal 14, via a mount 40. The mount 40 includes a non-rotating base 42, through which the collar 34 is threaded, and a rotating portion 44. The rotating portion 44 is coupled to the non-rotating portion 42 via a bearing 46, which allows the rotating portion 44 to rotate relative to the non-rotating portion 42. The camera 30 is connected to the rotating portion 44 such that, when the portion 44 rotates, the camera 30 rotates along with it. In the embodiment illustrated, the rotating portion 44 includes a receptacle 48 for securely connecting the camera 30 to the mount 40.

In some embodiments, a counterweight 50 is affixed to the rotating portion 44. As a result, when the dog 14 changes position, causing the angle of inclination of the camera 30 to change, the counterweight 50 will cause the rotating portion 44 of the mount 40 to automatically rotate, thereby substantially maintaining the view vector 32 of the camera 30.

In certain advantageous embodiments, bearing 46 is a rotation retarding bearing that somewhat retards the motion of the rotating portion 44 in order to slow its rotation. In this way, even when the perspective of the animal changes quickly, the speed at which the counterweight 50 causes the rotating portion 44 to rotate will be limited. As a result, the view vector 32 will not reorient too quickly such that the video becomes choppy or blurred, making it difficult for the viewer to get a fix on the animal's surroundings.

While in some of these embodiments, the rotation retarding bearing is a friction bearing 46, in other embodiments, other types of bearings that retard the rate of rotation may be employed. Moreover, it should be noted that other types of rotation devices may likewise be used, such as an electromechanical device for rotating the camera 30, which may be powered by the same power source as the camera 30 itself.

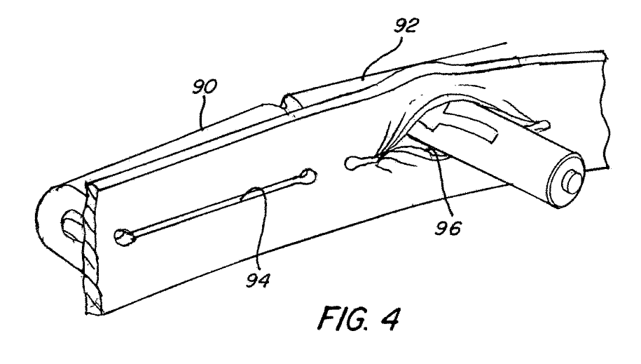

The camera (and possibly, a rotation device) may be powered in different ways. For example, as shown in FIG. 1, a battery container, such as a pouch 70, may be mounted to the collar 34. The pouch 70 holds at least one disposable or rechargeable battery, such as a nine volt battery, which is electrically connected to the camera 30. In such embodiments, wires providing this electrical connection (not shown) may run through the webbing of the collar 34. In some of these embodiments, and as shown more clearly in FIG. 4, the pouches 90, 92 are accessed via openings in the back surfaces of the pouches that abut the collar 34, and openings 94, 96 are provided in the collar 34 to facilitate this. This arrangement allows one to access the batteries (i.e., to remove them for replacement or recharging) only when the collar is removed from the dog's neck, thereby preventing any safety concerns that may arise from the dog scratching itself or otherwise knocking loose the battery.

In certain embodiments, circuitry is employed to limit the power consumption from the batteries and thereby extend their life. Multiple batteries or power packs may also be employed, such that one can switch off one of them. In other embodiments, solar cells may be mounted to the outer rim of collar 34 for storing and providing the requisite power. Additionally, sensors, such as motion or heat sensors, may also be employed such that the device can effectively be in a sleep mode when there are no active changes to the animal's environment.

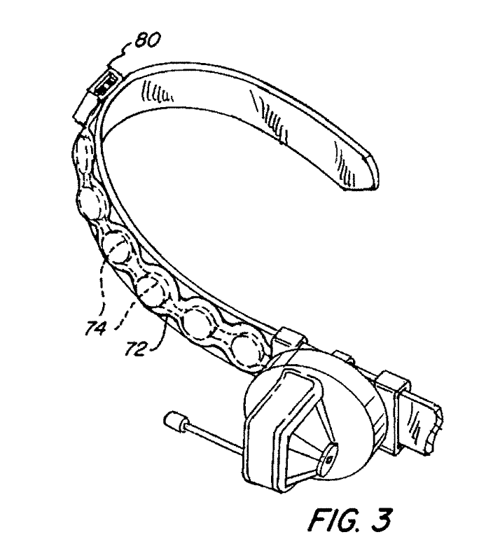

As illustrated in FIG. 3, in other embodiments, part or all of the collar 34 may be fashioned from different packs or segments 72 that retain a plurality of cell batteries 74 therein, which are connected in series and to the camera 30. In such embodiments, the collar may include an adaptor 80 such that, in embodiments where the collar 34 includes, for example, a series of gel batteries, the collar 34 can just be removed from the animal 14 and plugged into a wall to recharge. In some of these embodiments, either the camera 30 or the mount 40, or both, are easily detachable from the collar 34, such that a fully charged replacement collar 34 can be used with the camera 30 while another one charges.

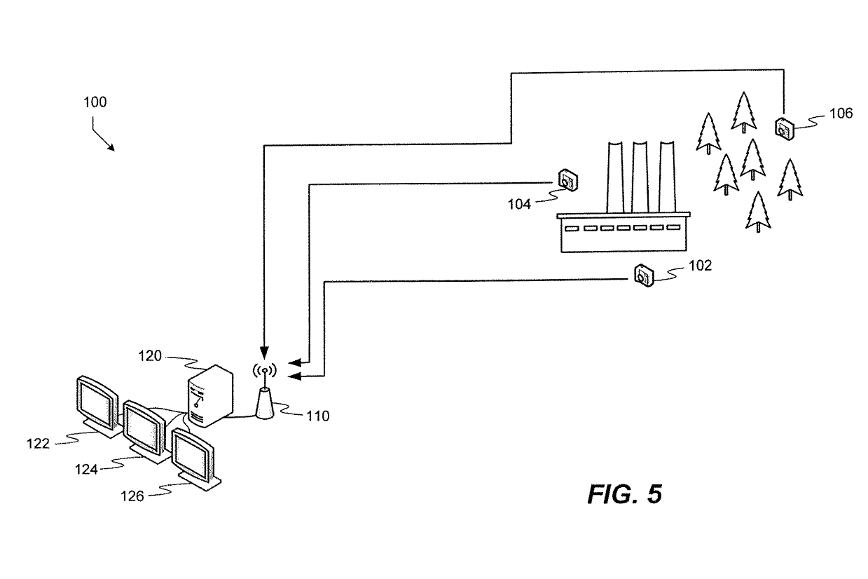

FIG. 5 illustrates one implementation of the above-described system. A plurality of video acquisition of devices 102, 104,106 are worn on guard dogs (not shown) at different locations at a large industrial facility. As each device 102, 104, 106 acquires video of its respective animal's surroundings, it wirelessly transmits this data to a remote monitoring device, which will, for example, include a wireless access point 110 that receives the wireless signal and communicates it to a computer 120 connected thereto. The remote monitoring device also includes at least one display, which may, for example, be a single computer monitor that displays the video from the different devices 102, 104, 106 in different windows, or a plurality of displays 122, 124, 126 that display the video from the devices 102, 104, 106, respectively.

The signals coming from the different cameras 102, 104, 106 may be received and routed appropriately via various methods, such as, for example, by having each such camera insert a unique code into the signal transmitted therefrom, which is identified and processed by software in the monitoring device, or, as another example, by using a different wireless access point 110 for each of the devices 102, 104, 106. In certain embodiments, the computer 120 has software executing thereon that converts the wireless signal received from the video acquisition devices 102, 104, 106 to USB.

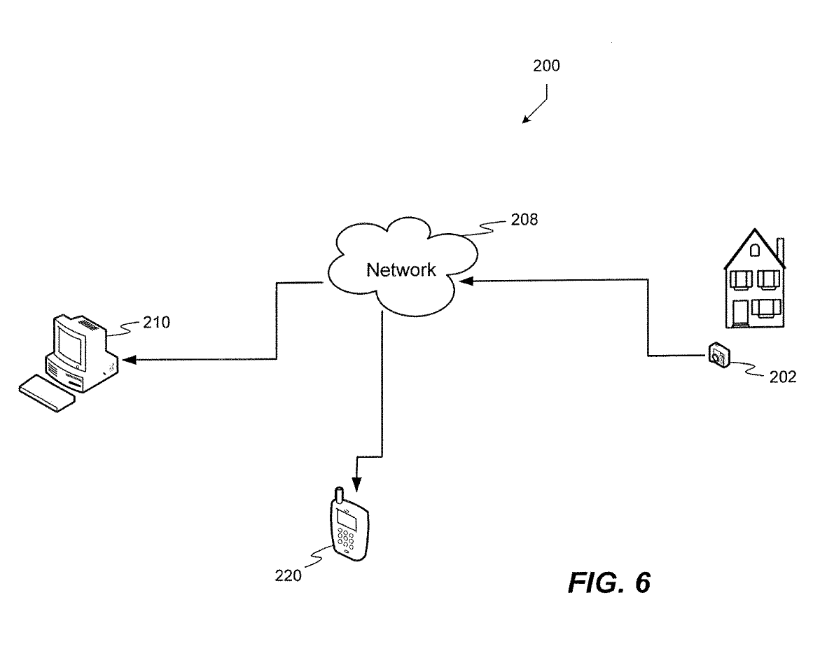

FIG. 6 illustrates another implementation of the above-described system. A video acquisition device 202 is worn on a guard dog (not shown) at a residential home. The device 202 acquires video of the dog's surroundings and wirelessly transmits it to a network 208, which may include, for example, the Internet. This data is then retrieved via the Internet by a monitoring device, such as a computer 210, or on a handheld device 220, on which a user can view the video. In this way, a homeowner or security personnel can monitor the dog's surroundings from inside the dwelling, a remote security station, or while traveling.

In certain embodiments, the monitoring device further includes a storage device for storing the video. This storage, which may occur automatically during live display or only at the command of a user, may simply comprise temporary memory so that a user can ‘rewind’ the video for a certain period of time, or can be long term storage, such as a computer drive or a portable media, such as DVD or video cassette.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A system for monitoring the environment of an animal, comprising:
a video acquisition device worn by an animal moving in an environment; and
a monitoring device with which a user remotely monitors the environment in which the animal moves;
wherein the video acquisition device comprises a camera with a view vector that acquires video data, a transmitter that wirelessly transmits the video data to the monitoring device, and a rotation device that substantially maintains a vertical angle of the view vector as the animal moves; and
wherein the monitoring device comprises a receiver that receives the wirelessly transmitted video data from the video acquisition device, and a display that displays the video data as live video to the user.

2. The system of claim 1, wherein said rotation device comprises a mount having a rotating portion, and wherein said camera is mounted to said rotating portion such that said camera rotates.

3. The system of claim 2, wherein said video acquisition device further comprises a counterweight that causes said rotating portion to rotate as the animal changes position.

4. The system of claim 3, wherein said mount further comprises:
a non-rotating portion; and
a rotation retarding bearing by which said rotating portion is coupled to said non-rotating portion such that the speed at which said rotating portion rotates is retarded.

5. The system of claim 4, wherein said rotation retarding bearing comprises a friction bearing.

6. The system of claim 1, wherein said monitoring device further comprises a converter that converts the wireless transmission to USB.

7. A device for monitoring the environment of an animal, comprising:
a collar that is worn by the animal;
a camera mounted to said collar; and
a mount by which said camera is mounted to said collar;
wherein said mount comprises a rotation device for rotating said camera.

8. The device of claim 7, wherein said mount includes a rotating portion, and wherein said camera is mounted to said rotating portion such that said camera rotates.

9. The device of claim 8, further comprising a counterweight affixed to said rotating potion that causes said rotating portion to rotate when the angle of inclination of said camera changes.

10. The device of claim 9, wherein said mount further comprises:
a non-rotating portion; and
a rotation retarding bearing by which said rotating portion is coupled to said non-rotating portion such that the speed at which said rotating portion rotates is retarded.

11. The device of claim 10, wherein said rotation retarding bearing comprises a friction bearing.

12. The device of claim 7, wherein said camera acquires video data, further comprising a wireless transmitter that transmits a signal with the video data to a remote location.

13. The device of claim 12, further comprising a monitoring device for monitoring the environment at a location remote from the collar, said monitoring device comprising a receiver that receives the wireless signal transmitted by the wireless transmitter.

14. The device of claim 13, wherein said monitoring device further comprises a converter that converts the wireless signal to USB.

15. The device of claim 13, further comprising a display that displays the video data as live video.

16. The device of claim 13, further comprising a storage device that stores the video data.

17. The device of claim 7, further comprising at least one battery electrically connected to said camera, wherein said battery is mounted to said collar.

18. The device of claim 17, further comprising a container mounted to said collar, said container having a surface that abuts said collar when mounted thereto, wherein said at least one battery is disposed in said container, and wherein said surface has an opening therein for accessing said battery.

19. The device of claim 7, wherein said collar includes a plurality of segments, further comprising a plurality of cell batteries disposed in said plurality of segments and connected in series.

20. The device of claim 19, wherein at least one of said mount and said camera is detachable from said collar.

21. A system for monitoring the environment of an animal from a different location, comprising:
a collar that is worn by the animal moving in an environment; and
a camera mounted to said collar that acquires video of the environment;
wherein said camera wirelessly transmits the video to the different location; and
wherein said camera is mounted to said collar such that said camera rotates when the angle of inclination of said camera changes.

22. The system of claim 21, further comprising a receiving device that receives the wireless transmission from said camera.

23. The system of claim 22, further comprising a converter that converts the wireless transmission to USB.
